(19) United States
(12) Patent Application Publication
(10) Pub. No.: US 2012/0027595 A1
(43) Pub. Date: Feb. 2, 2012

(54) PITCHABLE WINGLET FOR A WIND TURBINE ROTOR BLADE

(75) Inventor: David Samuel Pesetsky, Greenville, SC (US)

(73) Assignee: GENERAL ELECTRIC COMPANY, Schenectady, NY (US)

(21) Appl. No.: 13/205,747

(22) Filed: Aug. 9, 2011

(51) Int. Cl. F03D 1/06

(52) U.S. Cl. 416/147

(57) ABSTRACT

A rotor blade for a wind turbine is disclosed. The rotor blade may include a blade root, a blade tip and a body. The body may include a base portion extending from the blade root and a winglet extending from the base portion to the blade tip. In addition, at least a portion of the winglet may be configured to be pitched independent of the base portion.

### FIELD OF THE INVENTION

The present subject matter relates generally to wind turbines and, more particularly, a wind turbine rotor blade having a pitchable winglet.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from the wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. One such modification has been to increase the length and surface area of the rotor blades. However, the magnitude of deflection forces and loading of a rotor blade is generally a function of blade length, along with wind speed, turbine operating states, blade stiffness, and other variables. This increased loading not only produces fatigue on the rotor blades and other wind turbine components but may also increase the risk of a sudden catastrophic failure of the rotor blades, for example when excess loading causes deflection of a blade resulting in a tower strike.

To reduce the effective length of a rotor blade without significantly impacting its performance, it is known to include a wingtip device, such as winglet, at the tip of each rotor blade. However, even with the shortened effective length that can be achieved using a winglet, loads acting on a rotor blade, particularly in high speed wind conditions, may still cause the blade to deflect significantly towards the tower. Moreover, due to its orientation on the rotor blade as well as its aerodynamic profile, a winglet generates lift forces that cause bending moments to be applied at the tip of the rotor blade. These bending moments result in an increase in the amount of blade deflection, which, in some instances, may further decrease the amount of clearance between the rotor blade and the wind turbine tower.

Accordingly, a rotor blade having a pitchable winglet that permits the loads exerted by the winglet on the blade to be adjusted and/or controlled would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a rotor blade for a wind turbine. The rotor blade may include a blade root, a blade tip and a body. The body may include a base portion extending from the blade root and a winglet extending from the base portion to the blade tip. Additionally, at least a portion of the winglet may be configured to be pitched independent of the base portion.

In another aspect, the present subject matter discloses a rotor blade for a wind turbine. The rotor blade may include a blade root, a blade tip and a body. The body may include a base portion extending from the blade root and a winglet extending from the base portion to the blade tip, wherein at least a portion of the winglet may be configured to be pitched independent of the base portion. In addition, the winglet may be further configured to pivot relative to the base portion between an in-line position and a winglet position.

In a further aspect, the present subject matter discloses a wind turbine. The wind turbine may generally include a plurality of rotor blades. Each rotor blade may include a blade root, a blade tip and a body. The body may include a base portion extending from the blade root and a winglet extending from the base portion to the blade tip. Additionally, at least a portion of the winglet may be configured to be pitched independent of the base portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a perspective view of one embodiment a rotor blade having a pitchable winglet;

FIG. 3 illustrates a partial, side view of the rotor blade shown in FIG. 2, particularly illustrating a side view of the pitchable winglet;

FIG. 4 illustrates a cross-sectional view of the winglet shown in FIG. 3 taken along line 4-4;

FIG. 5 illustrates a partial, side view of an embodiment of a rotor blade having a pitchable and pivotable winglet, particularly illustrating the winglet in a winglet position;

FIG. 6 illustrates another partial, side view of the rotor blade shown in FIG. 5, particularly illustrating the winglet after it has been moved from the winglet position to an in-line position;

FIG. 7 illustrates a partial, side view of another embodiment of a rotor blade having a pitchable and pivotable winglet;

FIG. 8 illustrates a spanwise view of the rotor blade shown in FIG. 7, particularly illustrating a spanwise view of the winglet taken about line 8-8; and,

FIG. 9 illustrates a cross-sectional view of the winglet shown in FIG. 8 taken along line 9-9.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a rotor blade having a pitchable winglet in order to control the loads exerted on the rotor blade by the winglet. Specifically, the winglet may be configured to be actively pitched in order to control the lift forces generated by the winglet in a manner that minimizes blade deflection towards the tower of a wind turbine. For example, when a rotor blade includes a pressure side winglet, the winglet may be pitched so that the lift force generated by the winglet produces a lift vector directed in an inboard direction, thereby producing a bending moment on the rotor blade that tends to bow or flex the blade away from the tower. Moreover, the disclosed winglet may be used to improve the aerodynamic efficiency of a rotor blade and/or to increase the amount of energy captured by a rotor blade.

It should be appreciated that, by reducing blade deflection towards the tower, numerous advantages may be provided to a wind turbine. For example, reduced blade deflection may allow for a lighter rotor blade to be utilized, thereby increasing the overall performance of the wind turbine. In addition, reduced blade deflection may result in decreased fatigue loading on the rotor blades, thereby reducing damage to the blades and increasing their operating life. Moreover, due to the increased tower clearance, suction side winglets may be utilized without significantly increasing the likelihood of a tower strike.

It should also be appreciated that, in several embodiments, the disclosed winglet may be pivotally connected to the remainder of the blade such that the winglet is movable between an in-line position, wherein the winglet is aligned with the pitch axis of the rotor blade, and a winglet position, wherein the winglet is angled relative to the pitch axis of the rotor blade. By configuring the winglet in this manner, the effective length of the rotor blade may be adjusted depending on the operating conditions of the wind turbine. For example, in low load conditions wherein blade deflection is relatively small, the winglet may be moved to the in-line position to increase the effective length of the rotor blade, thereby increasing its ability to capture energy from the wind. However, in high load conditions, the winglet may be moved to the winglet position to reduce the effective length of the rotor blade, thereby reducing the amount of deflection occurring due to the increased loads.

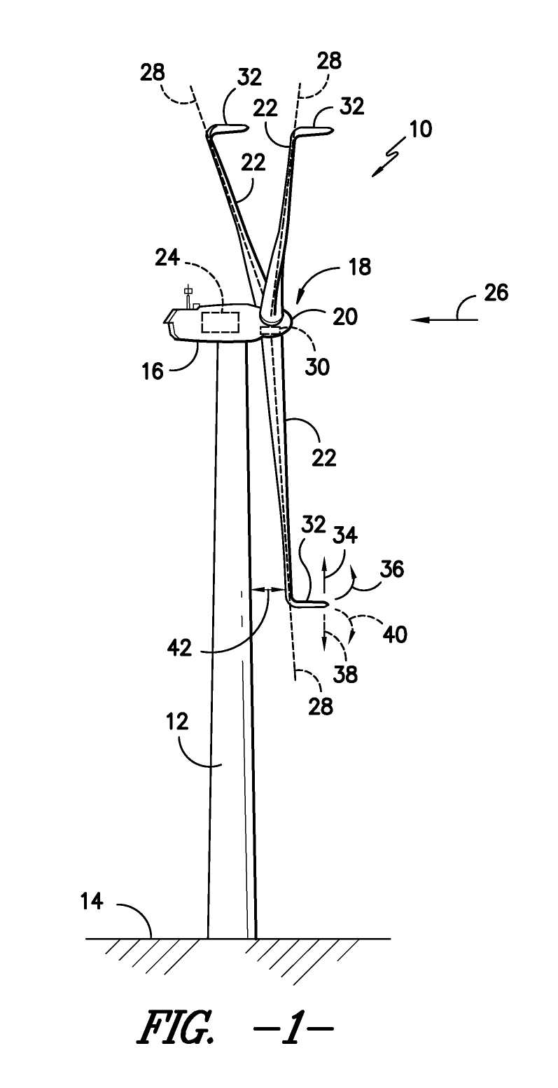

Referring now to the drawings, FIG. 1 illustrates perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22.

Additionally, the wind turbine 10 may also include a turbine control system or turbine controller 24 centralized within the nacelle 16. However, it should be appreciated that the turbine controller 24 may be disposed at any location on or in the wind turbine 10, at any location on the support surface 14 or generally at any other location. The controller 24 may generally be configured to control the various operating modes (e.g., start-up or shut-down sequences) and/or the components of the wind turbine 10. For example, the controller 24 may be configured to adjust a pitch angle or blade pitch of each of the rotor blades 22 (i.e., an angle that determines a perspective of the rotor blades 22 with respect to the direction 26 of the wind) in order to control the loads acting on and/or the power generated by the wind turbine 10 by adjusting an angular position of at least one of the rotor blades 22 relative to the wind. For instance, the controller 24 may control the blade pitch of the rotor blades 22 about their pitch axes 28, either individually or simultaneously, by controlling a suitable pitch adjustment mechanism 30 housed within the nacelle 16.

It should be appreciated that the turbine controller 24 may generally comprise a computer or any other suitable processing unit. Thus, in several embodiments, the turbine controller 24 may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the turbine controller 24 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the turbine controller 24 to perform various functions including, but not limited to, transmitting suitable control signals to the disclosed pitch adjustment mechanisms and the like. In addition, the controller 24 may also include various input/output channels for receiving inputs from sensors and/or other measurement devices and for sending control signals to various components of the wind turbine 10.

Referring still to FIG. 1, as shown, each rotor blade 22 generally includes a pressure side winglet 32. However, in alternative embodiments, each rotor blade 22 may include a suction side winglet. As is generally understood, winglets 32 may be used to improve the overall efficiency and performance of a wind turbine 10. For example, each winglet 32 may generally define an aerodynamic profile similar to the aerodynamic profile defined by the remainder of the rotor blade 22. As such, the winglets 32 may generate lift forces as the rotor blades 22 rotate about the rotor 18. However, depending on the orientation of each winglet 32 relative to the direction 26 of the wind, the magnitude and direction of the lift vector produced by the winglet 32 may vary significantly, which may, in turn, vary the loads that the winglet 32 exerts on the rotor blade 22, both on average and in extreme loading conditions. For example, as shown in FIG. 1, when the winglet 32 generates a lift vector 34 that is directed in a substantially inboard direction (e.g., in a direction generally towards the hub 20), a bending moment 36 may be applied by the winglet 32 that tends to flex or bow the rotor blade 22 away from the tower. Similarly, when the winglet 32 generates a lift vector 38 that is directed in a substantially outboard direction (i.e., in a direction generally away the hub 20), a bending moment 40 may be applied by the winglet 32 that tends to flex or bow the rotor blade 22 towards the tower. As such, winglet lift vectors 34 directed in the outboard direction tend to decrease the amount of tower clearance 42 defined between the rotor blade 22 and the tower 12, thereby increasing the likelihood of a tower strike.

It should be appreciated that, in embodiments in which each rotor blade 22 includes a suction side winglet, the bending moments 36, 38 generated by such winglets may be reversed. For example, lift vectors 38 generated by suction side winglets that are directed in the outboard direction will tend to flex or bow the rotor blade 22 away from the tower 12. Similarly, lift vectors 34 generated by suction side winglets that are directed in the inboard direction will tend to flex or bow the rotor blade 22 towards the tower 12.

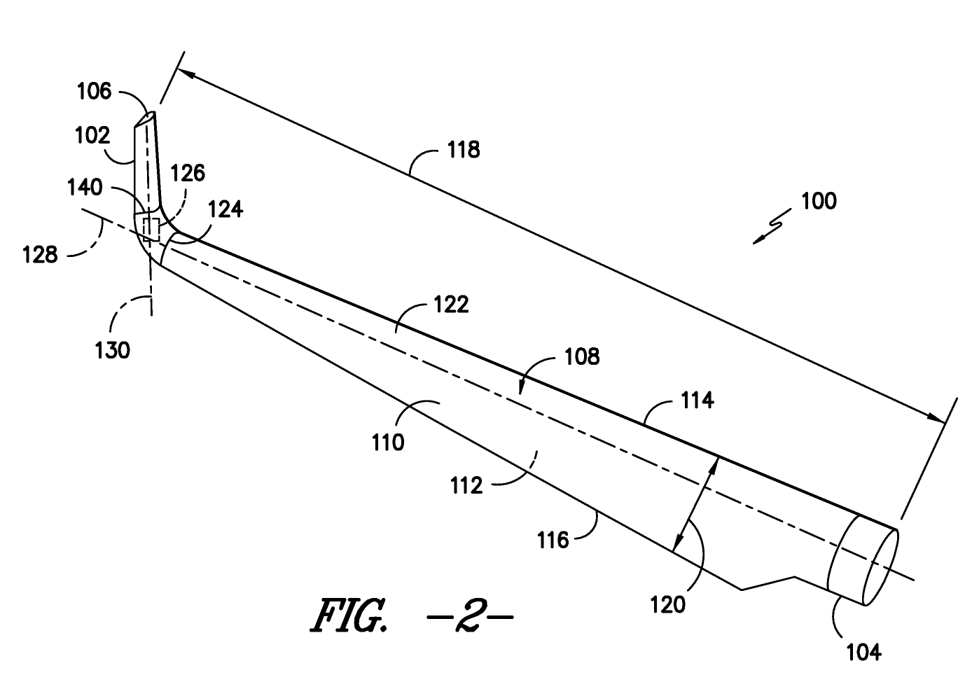

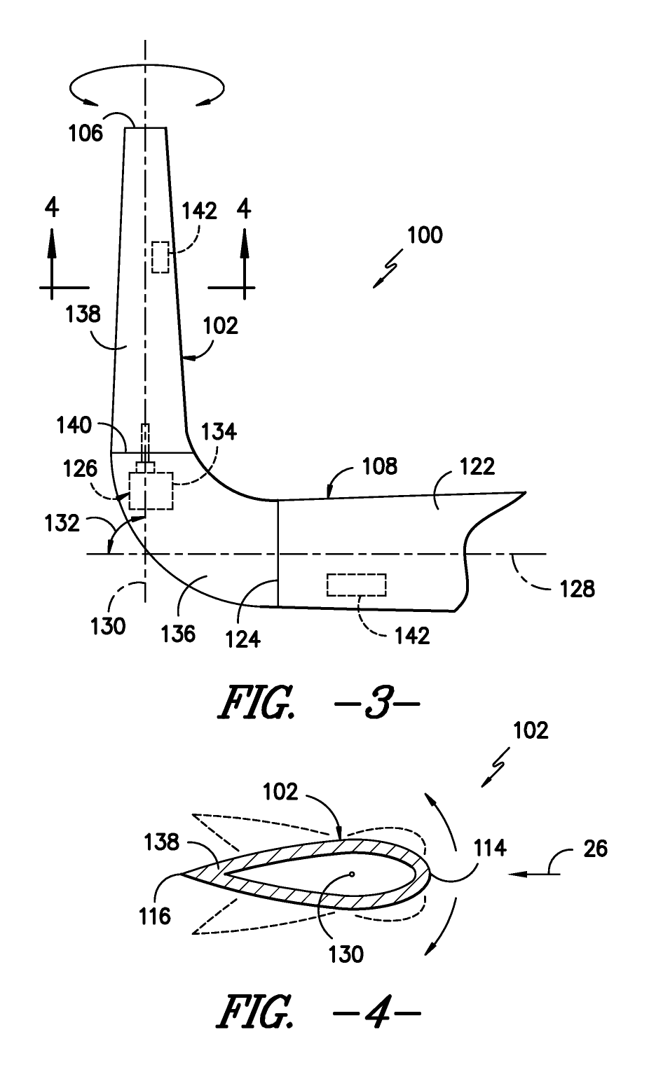

Referring now to FIGS. 2-4, various views of one embodiment of a rotor blade 100 having a pitchable winglet 102 is illustrated in accordance with aspects of the present subject matter. Specifically, FIG. 2 illustrates a perspective view of the rotor blade 100. FIG. 3 illustrates a partial, side view of the rotor blade 100, particularly illustrating a side view of the winglet 102. Additionally, FIG. 4 illustrates cross-sectional view of the winglet 102 taken along line 4-4.

As shown, the rotor blade 100 generally includes a blade root 104 configured for mounting the rotor blade 100 to the rotor hub 20 of the wind turbine 10 (FIG. 1) and a blade tip 106 disposed opposite the blade root 104. A body 108 of the rotor blade 100 may generally extend from the blade root 104 to the blade tip 106 and may serve as the outer shell of the rotor blade 100. As is generally understood, the body 108 may define an aerodynamic profile, such as by defining a symmetrical or cambered airfoil-shaped cross-section, to enable the rotor blade 100 to capture kinetic energy from the wind using known aerodynamic principles. As such, the body 108 may generally include a pressure side 110 and a suction side 112 extending between a leading edge 114 and a trailing edge 116. Additionally, the rotor blade 100 may have a span 118 defining the total length of the blade 100 between the blade root 104 and the blade tip 106 and a chord 120 defining the total length of the body 108 between the leading edge 114 and the trailing edge 116. As is generally understood, the chord 120 may vary in length with respect to the span 118 as the rotor blade 100 extends between the blade root 104 to the blade tip 106.

The body 108 of the rotor blade 100 may generally include a base portion 122 and a pitchable winglet 102 extending from the base portion 122. In particular, the base portion 122 may generally extend outwardly from the blade root 104 and may comprise the main airfoil section of the rotor blade 100. The winglet 102 may generally be configured as a wingtip device for improving the aerodynamic efficiency of the rotor blade 100 and, thus, may extend between the base portion 122 and the blade tip 106. As shown in the illustrated embodiment, the winglet 102 comprises a pressure side winglet. However, in alternative embodiments, the winglet 102 may comprise a suction side winglet.

It should be appreciated that, in several embodiments, the winglet 102 may be manufactured as a separate component from the base portion 122 and, thus, may be configured to be coupled to the base portion 122 using any suitable means and/or method known in the art (e.g., by using suitable fasteners, adhesives and like). For example, as shown in FIGS. 2 and 3, a blade joint 124 may be defined at the interface between the winglet 102 and the base portion 122 generally corresponding to the point of coupling of such components. Alternatively, the winglet 102 and the base portion 122 may be formed integrally as a single component. For instance, in one embodiment, the entire body 108 (including the winglet 102 and the base portion 122) may be initially cast together in a common mold.

Referring still to FIGS. 2-4, the rotor blade 100 may also include a pitch adjustment mechanism 126 disposed within the body 108 that is separate from the pitch adjustment mechanism 30 (FIG. 1) adapted to rotate the entire rotor blade 100 about its pitch axis 128. In general, the pitch adjustment mechanism 126 may be configured to pitch the winglet 102 relative to and/or independent from the base portion 122 of the body 108. Specifically, in several embodiments, the pitch adjustment mechanism 126 may be configured to rotate at least a portion of the winglet 122 about a winglet pitch axis 130 oriented at an angle 132 relative to the pitch axis 128 of the rotor blade 100. For example, as particularly shown in FIG. 3, the angle 132 defined between the winglet pitch axis 130 and the blade pitch axis 128 may be equal to about 90 degrees. However, in alternative embodiments, the angle 132 may be less then 90 degrees or greater than 90 degrees.

In general, the pitch adjustment mechanism 126 may comprise any suitable device and/or combination of devices known in the art that may be configured to pitch at least a portion of the winglet 102 about its pitch axis 130. For example, as particularly shown in FIG. 3, the pitch adjustment mechanism 126 may, in one embodiment, comprise a motor 134 (e.g., an electric motor) coupled to a portion of the winglet 102. In such an embodiment, the motor 134 may be directly coupled to winglet 102 (e.g., by directly coupling the output shaft of the motor 134 to a portion of the winglet 102) or the motor 134 may be indirectly coupled to the winglet 102 (e.g., by coupling the motor 134 to a portion of the winglet 102 through a gearbox, any suitable linkage or coupling and/or any other suitable component). In other embodiments, the pitch adjustment mechanism 126 may comprise any other suitable rotational motion device and/or arrangement. For instance, the pitch adjustment mechanism 126 may comprise other gear driven devices, belt and pulley arrangements, ball and socket arrangements and the like. In even further embodiments, the pitch adjustment mechanism 126 may comprise one or more suitable actuators whose output(s) may be converted into rotational motion through suitable linkages and/or couplings. For instance, the pitch adjustment mechanism 126 may comprise a linear actuator (e.g., a pneumatic or hydraulic cylinder, a electro-mechanical actuator, a solenoid actuated device and/or the like) coupled to the winglet 102 through suitable linkages and/or couplings.

As indicated above, in several embodiments, the pitch adjustment mechanism 126 may only be configured to pitch a portion of the winglet 102 about the winglet pitch axis 120. For example, as shown in FIG. 3, in one embodiment, the winglet 102 may include a first, fixed portion 136 rigidly coupled to the base portion 122 at the blade joint 124 and a second, rotatable portion 138 extending outwardly from the fixed portion 136 towards the blade tip 106. In such an embodiment, the rotatable portion 138 may generally be configured to be rotated about the winglet pitch axis 130 at a pitch joint 140 defined at the interface between the fixed portion 136 and the rotatable portion 136. For example, as shown in the illustrated embodiment, the pitch adjustment mechanism 126 may be coupled to the rotatable portion 138 at or adjacent to the pitch joint 140 to permit the rotatable portion 138 to be pitched relative to the fixed portion 136.

It should be appreciated that, in alternative embodiments, the entire winglet 102 may be configured to be pitched relative to the base portion 122 of the rotor blade 100. For example, the pitch adjustment mechanism 126 may be coupled to the winglet 102 at or adjacent to the blade joint 124 such that the winglet 102 may be pitched relative to the base portion 122 at such joint 124.

By configuring at least a portion of the winglet 102 to be pitchable independent of the base portion 122, the orientation of the winglet 102 relative to the direction 26 of the wind may be actively adjusted in order to control the loads exerted by the winglet 102 on the rotor blade 100. For example, as particularly shown in FIG. 4, rotation of the winglet 102 about its pitch axis 130 may alter the orientation of the leading edge 114 of the winglet 102 relative to the wind direction 26, thereby adjusting the aerodynamic performance of the winglet 102. Thus, in several embodiments, the winglet 102 may be pitched in a manner that minimizes deflection of the rotor blade 100 towards the wind turbine tower 12 (FIG. 1), thereby decreasing the likelihood of a tower strike occurring. For example, when a pressure side winglet 102 is included on the rotor blade 100, it may be desirable to pitch the winglet 102 in a manner that causes the lift vector 34 (FIG. 1) generated by the winglet 102 to be directed in the inboard direction, thereby producing a bending moment 36 (FIG. 1) at the blade tip 106 that tends to bow the rotor blade 100 away from the tower 12. In such an embodiment, it should be appreciated that the winglet 102 may be pitched so that the lift vector 34 is continuously directed in the inboard direction (e.g., by continuously pitching the winglet 102 around the entire rotational path of the blade 100 in order to maintain the lift vector 34 directed in the inboard direction) or the winglet 102 may be pitched so that the lift vector 34 is only directed in the inboard direction at particular rotor positions (e.g., by actively pitching the winglet 102 so that the lift vector 34 is directed in the inboard direction as the rotor blade 100 passes the tower 12).

It should be appreciated that, in several embodiments, the winglet 102 may be actively pitched using the turbine controller 24 described above. For example, the pitch adjustment mechanism 126 may be communicatively coupled to the turbine controller 24 (e.g., via a wired or wireless connection) so that suitable control signals may be transmitted from the controller 24 to the pitch adjustment mechanism 126 in adjust the pitch of the winglet 102. In such embodiments, it should be appreciated that the turbine controller 24 may be configured to receive any manner of input from various sensors 142 disposed on and/or within the rotor blade 100 or at any other suitable location on, within and/or around the wind turbine 10 that are configured to monitor various operating conditions of the rotor blade 100 and/or the wind turbine 10. For example, the sensors 142 may be configured to sense, detect and/or measure operating conditions such as, but not limited to, loads acting on the rotor blade 100, the orientation of the winglet 102 relative to the direction 26 of the wind, the amount of tower clearance 42 present, wind conditions (e.g., wind speed and direction), and the like and then transmit suitable signals to the turbine controller 24 corresponding to the operating condition(s) being monitored. The turbine controller 24 may then be configured to analyze such operating conditions and determine when and/or to what extent to pitch each winglet 102 about its pitch axis 130 in order to control the loads generated by each winglet 102 and/or to optimize the overall efficiency and/or performance of the rotor blade 100.

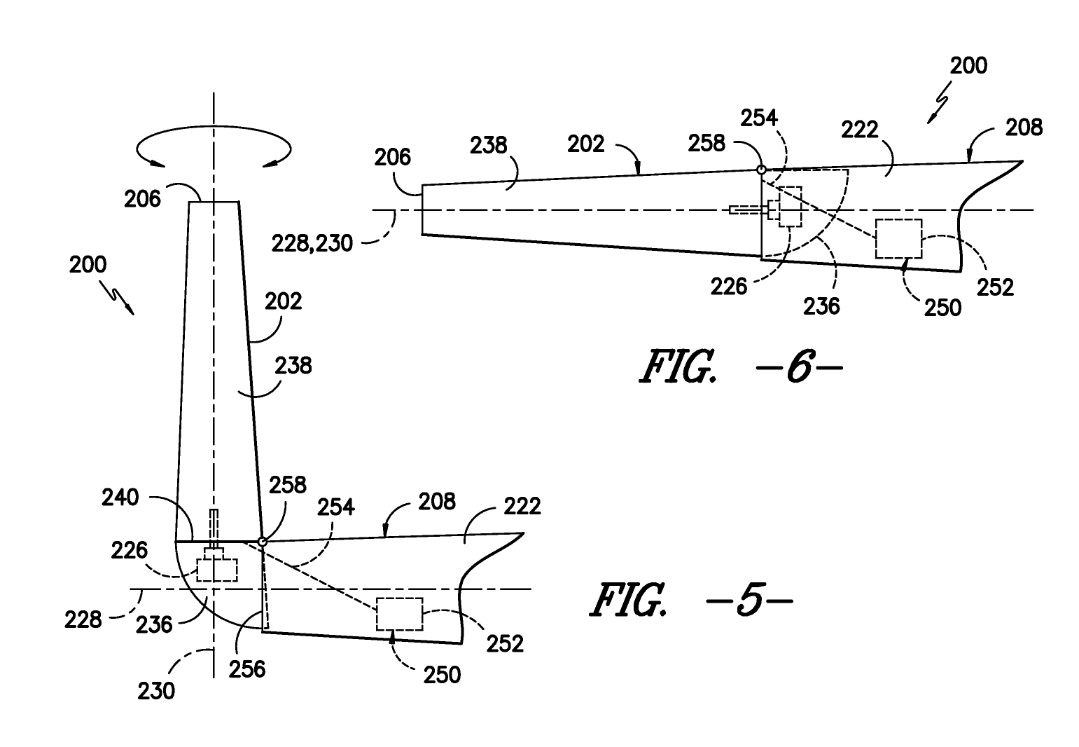

Referring now to FIGS. 5 and 6, a partial view of another embodiment of a rotor blade 200 is illustrated in accordance with aspect of the present subject matter. In general, the illustrated rotor blade 200 may be configured similarly to the rotor blade 100 described above. For example, the rotor blade 200 may include a body 208 having a base portion 222 extending from a blade root 104 (FIG. 2) and a pitchable winglet 202 extending from the base portion 222 towards a blade tip 206. In addition, the rotor blade 200 may include a pitch adjustment mechanism 226 configured to pitch a rotatable portion 238 of the winglet 202 about a winglet pitch axis 230. As such, the orientation of the winglet 202 relative to the direction 26 of wind (FIG. 4) may be adjusted independent of the base portion 222.

However, unlike the embodiment described above, in addition to being pitchable, the winglet 202 may also be configured to be movable from a winglet position (shown in FIG. 5), wherein the winglet pitch axis 230 is oriented at an angle relative to the blade pitch axis 228, to an in-line position (shown in FIG. 6) wherein the winglet pitch axis 230 is generally aligned with the blade pitch axis 228. Specifically, the rotor blade 200 may include an actuating mechanism 250 provided at any suitable location within the base portion 222 for moving the winglet 202 between the winglet and in-line positions. For example, as shown in the illustrated embodiment, the actuating mechanism 250 may comprise a piston 252 coupled to the winglet 202 by a suitable linkage and/or coupling 254. However, in alternative embodiments, the actuating mechanism 250 may generally comprise any the suitable active control mechanism that is configured to receive control signals from the turbine controller 24 in order to retract and/or deploy the winglet 202. For instance, the actuating mechanism 250 may comprise an electric motor, a pneumatic or hydraulic cylinder, a electro-mechanical actuator, a solenoid actuated device and/or the like. In further embodiments, the actuating mechanism 250 may also include a passive component, such as a spring, or other biasing member that may be configured to bias the winglet 202 to either of the in-line or winglet positions. In such an embodiment, an active device, such as a motor, piston, or the like, may then be used to move the winglet 202 in the respective opposite direction against the bias force of the spring or other biasing member.

It should also be appreciated that the actuating mechanism 250 may be configured to variably actuate the winglet 202 to any suitable winglet position. For example, as shown in FIG. 5, the winglet 202 has been actuated to a position at which the winglet pitch axis 230 is generally disposed at a 90 degree angle relative to the blade pitch axis 228. However, in alternative embodiments, the actuating mechanism 250 may be configured to actuate the winglet 202 such that the angle defined between the winglet pitch axis 230 and the blade pitch axis 228 is less than 90 degrees or greater than 90 degrees.

In addition, unlike the fixed portion 136 of the winglet 100 described above with reference to FIG. 3, the illustrated winglet 200 may include a pivoting portion 236 configured to be pivotally coupled to the base portion 222 of the rotor blade 200 to permit the winglet 200 to be pivoted between the winglet and in-line positions. Specifically, as shown in the illustrated embodiment, the pivoting portion 236 may be configured to extend generally between a pitch joint 240 defined at the interface between the rotating portion 238 and the pivoting portion 236 and an end 256 of the base portion 222 when the winglet 202 is in the winglet position. However, when the winglet 202 is moved to the in-line position, the pivoting portion 236 may be configured to deployed within or otherwise pivot into the base portion 222. For instance, in several embodiments, the pivoting portion 236 may comprise a rigid or semi-rigid, arcuate shaped member that is configured to swing into the base portion 222 when the winglet 202 is moved to the in-line position and swing out of the base portion 222 when the winglet 202 is moved to the winglet position. In an alternative embodiment, the pivoting portion 236 may be compressible so as to fit within the base portion 222 in the in-line position, but may assume its arcuate or extended shape upon deployment to the winglet position. For instance, the pivoting portion 236 may be formed from any suitable pliable, conformable and/or elastic material (e.g., a canvas or other suitable sheet material, a pleated material, a collapsible material, and so forth) so that the pivoting portion 236 is capable of being folded or otherwise reduced in size into deployed or stowed position within the base portion 222 and/or the winglet 202 when the winglet 202 is moved to the in-line position.

It should be appreciated that the pivoting portion 236 of the winglet 202 may generally be pivotally coupled to the base portion 222 using any means known in the art. For example, as shown in the illustrated embodiment, the pivoting portion 230 may be coupled to the base portion 222 with a hinge joint 258 defined by any suitable hinge structure, such as a mechanical hinge, a living hinge, and so forth.

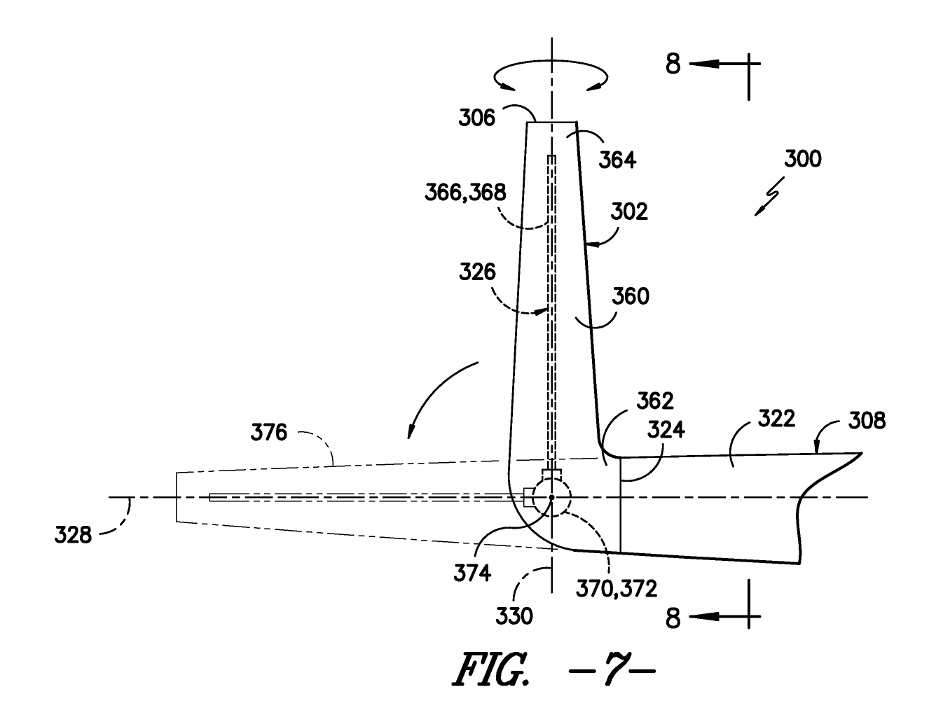

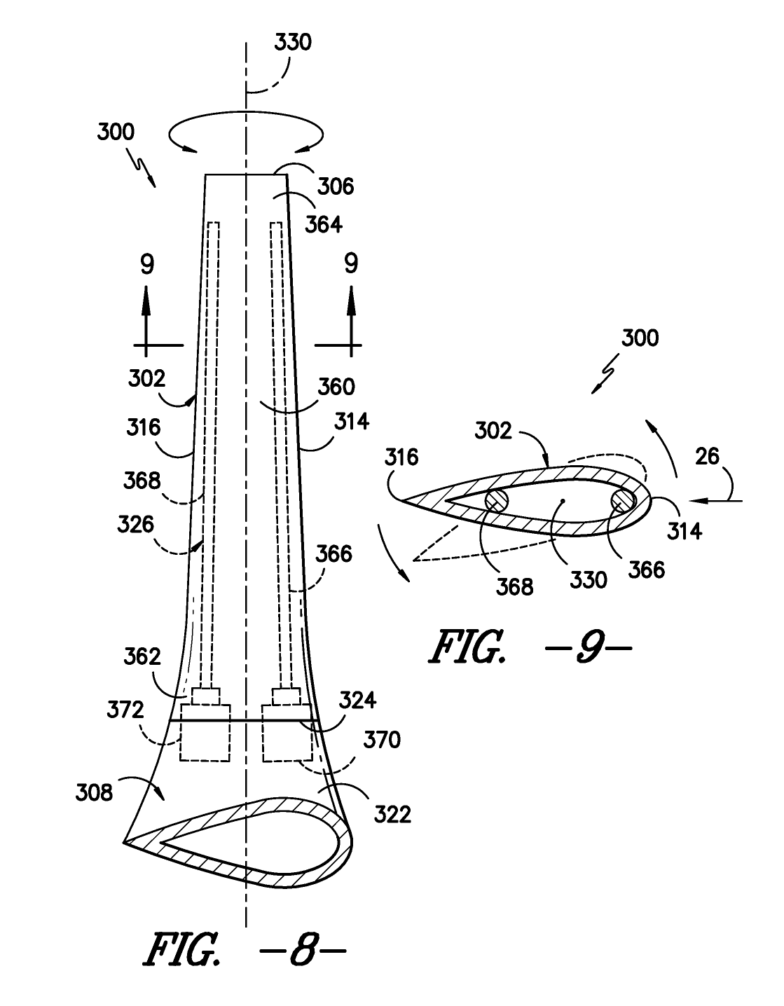

Referring now to FIGS. 7-9, various views of a further embodiment of a rotor blade 300 having a pitchable winglet 302 are illustrated in accordance with aspects of the present subject matter. Specifically, FIG. 7 illustrates a partial, side view of the rotor blade 300, particularly illustrating a side view of the winglet 302. FIG. 8 illustrates a partial, spanwise view of the rotor blade 300 looking from the hub 18 of the wind turbine 10 (FIG. 1), particularly illustrating a spanwise view of the winglet 302 taken along line 8-8. Additionally, FIG. 9 illustrates a cross-sectional view of the winglet 302 taken along line 9-9.

In general, the illustrated rotor blade 300 may be configured similarly to the rotor blades 100, 200 described above with reference to FIGS. 2-6. For example, the rotor blade 300 may include a body 308 having a base portion 322 extending from a blade root 104 (FIG. 2) and a pitchable winglet 302 extending from the base portion 322 towards a blade tip 306. In addition, the rotor blade 300 may include a pitch adjustment mechanism 326 configured to pitch a at least a portion of the winglet 302 about a winglet pitch axis 330. As such, the orientation of the winglet 302 relative to the direction 26 of wind may be adjusted independent of the base portion 322.

However, unlike the embodiments described above, the illustrated pitch adjustment mechanism 326 may be configured to control the pitch of the winglet 302 by flexing or otherwise deforming the winglet 302 along its length. Specifically, in several embodiments, at least a portion of the winglet 302 may be formed from a flexible and/or deformable material that is capable of being flexed and/or deformed by the pitch adjustment mechanism 326. For example, as shown in FIG. 7, in one embodiment, the winglet 302 may be configured as a flexible sleeve 360 having a first end 362 coupled to the base portion 322 at the blade joint 324 and a second end 364 terminating at the blade tip 306. In such an embodiment, the flexible sleeve 360 may be formed from any suitable material that is capable of maintaining the winglet's aerodynamic profile (e.g., an airfoil shaped cross-section) when in an unstressed state, but may be flexed and/or deformed when a force is applied to it. For instance, the flexible sleeve 360 may be formed from various suitable polymer materials, rubber materials and/or the like.

Additionally, the pitch adjustment mechanism 326 may generally comprise any suitable device and/or combination devices that are configured to flex and/or deform the winglet 302 in order to adjust the winglet's orientation relative to the wind. For example, as shown in the illustrated embodiment, the pitch adjustment mechanism 326 may include a first rod 366 extending adjacent to and/or being coupled to the leading edge 314 of the winglet 302 and a second rod 368 extending adjacent to and/or being coupled to the trailing edge 316 of the winglet 302. In addition, the pitch adjustment mechanism 326 may include one or more actuators 370, 372 configured to actuate the rods 366, 368 in one or more directions. For example, as particularly shown in FIG. 8, the pitch adjustment mechanism 326 may include a first actuator 370 coupled to the first rod 366 and a second actuator 372 coupled to the second rod 368. Each actuator 370, 372 may generally be configured to actuate its respective rod 366, 368 (e.g., by rotating each rod 366, 368 about an actuation point 374 (FIG. 7)) in order to flex and/or deform at least a portion of the winglet 302 is along its length.

By actuating one or both of the rods 366, 368, the orientation of the winglet 302 relative to the direction 36 of the wind may be adjusted. For example, as shown in FIG. 9, by actuating the first and second rods 366, 368 in opposite directions (e.g., by rotating the rods 366, 368 in opposite directions about the actuation point 374), the winglet 302 may be twisted, flexed and/or deformed along its length, thereby altering positions of the leading and trailing edges 314, 316 of the winglet 302 relative to the wind and adjusting the pitch of the winglet 302 about the pitch axis 330. In another embodiment, only one of the rods 366, 368 may be actuated within the winglet 302 in order to adjust the position of the leading edge 314 or the trailing edge 316 relative to the direction 36 of the wind.

It should be appreciated that the first and second rods 366, 368 may generally comprise any suitable elongated members that have sufficient stiffness and/or rigidity to permit the winglet 302 to be flexed and/or deformed when the rods 366, 368 are actuated. For example, the rods 366, 368 may be formed from various rigid and/or semi-rigid materials, such as one or more metal materials, hard plastic materials and the like. Additionally, it should be appreciated that the actuators 370, 372 may generally comprise any suitable device and/or combination of devices that may be configured to actuate the rods 366, 368 in one or more directions. For example, the actuators 370, 372 may comprise motors, electro-mechanical actuators, solenoid actuated devices, pneumatic or hydraulic cylinders and the like. Moreover, in several embodiments, the pitch adjustment mechanism 326 may only include a single rod, such as by including a single rod extending adjacent to or being coupled to the leading edge 314 or trailing edge 316. Similarly, the pitch adjustment mechanism 326 need not include both a first actuator 370 and a second actuator 372. For example, in one embodiment, a single actuator may be coupled to the first and second rods 366, 368 and may be configured to actuate the rods 366, 368 simultaneously and/or individually.

It should also be appreciated that, in alternative embodiments, the pitch adjustment mechanism 326 may include any other suitable components and/or may have any other suitable arrangement that permits it to function as described herein. For example, the pitch adjustment mechanism 326 may simply comprise one or more linear actuators configured to flex and/or otherwise deform a portion of the winglet 302.

In addition, as particularly shown in FIG. 7, in several embodiments, the winglet 302 may also be configured to be moved from a winglet position, wherein the winglet pitch axis 330 is oriented at an angle relative to the blade pitch axis 328, to an in-line position (indicated by the dashed lines 376), wherein the winglet pitch axis 330 is generally aligned with the blade pitch axis 328. In particular, the flexible and/or deformable nature of the material used to form the winglet 302 may allow the winglet 302 to be flexed and/or deformed in a manner that brings the winglet 302 into alignment with the base portion 322 of the rotor blade 300. Thus, as shown in the illustrated embodiment, the actuators 370, 372 of the pitch adjustment mechanism 326 may be configured to rotate the rods 366, 368 approximately 90 degrees about the actuation point 374, thereby aligning the winglet 302 with the pitch axis 328 of the rotor blade 300.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, the rotor blade comprising:
a blade root;
a blade tip; and,
a body, said body including a base portion extending from said blade root and a winglet extending from said base portion to said blade tip,
wherein at least a portion of said winglet is configured to be pitched independent of said base portion.

2. The rotor blade of claim 1, wherein said winglet defines a pitch axis oriented at an angle relative to a pitch axis of said base portion, said winglet being configured to be pitched about said pitch axis.

3. The rotor blade of claim 1, further comprising a pitch adjustment mechanism coupled to said winglet, said pitch adjustment mechanism being configured to pitch said winglet.

4. The rotor blade of claim 3, wherein said pitch adjustment mechanism comprises a motor coupled to said winglet.

5. The rotor blade of claim 4, wherein said winglet comprises a first portion coupled to said base portion and a second portion coupled to said first portion at a pitch joint, said motor being coupled to said second portion such that said second portion is pitched at said pitch joint.

6. The rotor blade of claim 3, wherein said pitch adjustment mechanism comprises a first rod extending adjacent to a leading edge of said winglet and a second rod extending adjacent to a trailing edge of said winglet, said first and second rods being configured to be actuated so as to pitch said winglet.

7. The rotor blade of claim 6, wherein said winglet comprises a flexible sleeve coupled to said base portion, said first and second rods being configured to pitch said winglet by deforming said flexible sleeve.

8. The rotor blade of claim 6, further comprising an actuator configured to actuate at least one of said first rod and said second rod.

9. The rotor blade of claim 8, wherein said actuator is configured to actuate said at least one of said first rod and said second rod such that said winglet is moved between an in-line position and a winglet position.

10. The rotor blade of claim 1, wherein said winglet is further configured to pivot relative to said base portion between an in-line position and a winglet position.

11. The rotor blade of claim 10, wherein said winglet comprises a first portion pivotally coupled to said base portion and a second portion extending from said first portion to said blade tip, said first portion being configured to extend between said second portion and said base portion when said winglet is in said winglet position, said first portion being configured to extend within one of said base portion and said second portion when said winglet is in said in-line position.

12. The rotor blade of claim 1, wherein said winglet is configured to be pitched such that a lift vector of said winglet is directed in an inboard direction.

13. A rotor blade for a wind turbine, the rotor blade comprising:
a blade root;
a blade tip; and,
a body, said body including a base portion extending from said blade root and a winglet extending from said base portion to said blade tip,
wherein at least a portion of said winglet is configured to be pitched independent of said base portion and wherein said winglet is further configured to pivot relative to said base portion between an in-line position and a winglet position.

14. A wind turbine, comprising:
a plurality of rotor blades, each of said plurality of rotor blades comprising:
a blade root;
a blade tip; and,
a body, said body including a base portion extending from said blade root and a winglet extending from said base portion to said blade tip,
wherein at least a portion of said winglet is configured to be pitched independent of said base portion.

15. The wind turbine of claim 14, further comprising a pitch adjustment mechanism coupled to said winglet, said pitch adjustment mechanism being configured to pitch said winglet.

16. The wind turbine of claim 15, wherein said pitch adjustment mechanism comprises a motor coupled to said winglet.

17. The wind turbine of claim 15, further comprising a controller configured control said pitch adjustment mechanism such that a lift vector of said winglet is directed in an inboard direction.

18. The wind turbine of claim 15, wherein said pitch adjustment mechanism comprises a first rod extending adjacent to a leading edge of said winglet and a second rod extending adjacent to a trailing edge of said winglet, said first and second rods being configured to be actuated so as to pitch said winglet.

19. The wind turbine of claim 18, wherein said winglet comprises a flexible sleeve coupled to said base portion, said first and second rods being configured to pitch said winglet by deforming said flexible sleeve.

20. The wind turbine of claim 14, wherein said winglet is further configured to pivot relative to said base portion between an in-line position and a winglet position.
